(19) United States
(12) Patent Application Publication
(10) Pub. No.: US 2025/0192149 A1
(43) Pub. Date: Jun. 12, 2025

(54) CATHODE ACTIVE MATERIAL FOR LITHIUM SECONDARY BATTERY AND METHOD OF MANUFACTURING THE SAME

(71) Applicants: Hyundai Motor Company, Seoul (KR); Kia Corporation, Seoul (KR); Research & Business Foundation SUNGKYUNKWAN UNIVERSITY, Suwon-si (KR)

(72) Inventors: Seung Min OH, Incheon (KR); Sung Ho BAN, Hwaseong-si (KR); Sang Hun LEE, Paju-si (KR); Chang Hoon SONG, Seoul (KR); Tae Ho PARK, Hwaseong-si (KR); Seung Tae KIM, Yongin-si (KR); Ki Kang LEE, Hwaseong-si (KR); Yoon Sung LEE, Suwon-si (KR); Eung Ju LEE, Daejeon (KR); Van Chuong HO, Suwon-si (KR); Jun Young MUN, Incheon (KR)

(73) Assignees: Hyundai Motor Company, Seoul (KR); Kia Corporation, Seoul (KR); Research & Business Foundation SUNGKYUNKWAN UNIVERSITY, Suwon-si (KR)

(21) Appl. No.: 18/657,364

(22) Filed: May 7, 2024

(30) Foreign Application Priority Data
Dec. 11, 2023 (KR) 10-2023-0179009

(51) Int. Cl. H01M 4/36; C01B 32/182; C01G 53/00; H01M 4/02; H01M 4/525; H01M 4/587

(52) U.S. Cl. CPC H01M 4/366; C01B 32/182; C01G 53/50; H01M 4/525; H01M 4/587; C01B 2204/32; C01P 2002/52; C01P 2002/82; C01P 2002/85; C01P 2004/80; C01P 2006/12; C01P 2006/40; H01M 2004/028

(57) ABSTRACT

A cathode active material is imparted with improved electrical conductivity and reduced electrolyte side reactions and thus electrochemical performance is improved through a coating layer with high crystallinity and high conductivity formed without separate heat treatment or solvent by physically displacing graphene separately prepared from a core on the surface of a core layer, and a method of preparing the same is provided.

### CROSS-REFERENCE TO THE RELATED APPLICATION

The present application claims priority to Korean Patent Application No. 10-2023-0179009, filed on Dec. 11, 2023, the entire contents of which is incorporated herein for all purposes by this reference.

### BACKGROUND OF THE PRESENT DISCLOSURE

### Field of the Present Disclosure

The present invention relates to a cathode active material that is imparted with improved electrical conductivity and reduced electrolyte side reactions, thus having improved electrochemical performance, through a coating layer with high crystallinity and high conductivity formed without separate heat treatment or solvent by physically displacing graphene separately prepared from a core on the surface of a core layer, and a method of preparing the same.

### Description of Related Art

Lithium secondary batteries are used as power sources for small portable devices owing to high energy density and light weight thereof. Recently, lithium secondary batteries have been in the spotlight as power sources for small home appliances and mobile electronics, as well as hybrid/electric vehicles (HEV/EV).

Generally, the cathode of lithium secondary batteries includes a cathode material, a conductor, a binder, and a current collector. In particular, a cathode material with excellent reversibility, low self-discharge rate, high capacity, and high energy density is required.

LiCoO₂(LCO), LiMn₂O₄(LMO), LiFePO₄ (LFP), Li(Ni_{X}Mn_{Y}Co_{Z})O₂(x+y+z=1)(NCM), LiNiCoAlO₂ (NCA), and the like are known as such cathode materials, especially nickel-based layered oxides (such as NCM and NCA) are mainly used.

Thereamong, lithium-nickel-cobalt-manganese oxide (NCM) has high performance and excellent stability as a cathode material and thus is attracting attention as a cathode material for lithium secondary batteries such as hybrid vehicles (HEV) and electric vehicles (EV), and demand therefor is also continuously increasing.

NCM, the aforementioned cathode active material, exhibits different electrochemical properties depending on the composition of nickel, cobalt, and manganese that constitute NCM. For example, nickel contributes to capacity, cobalt contributes to power output, and manganese contributes to structural stability. In particular, nickel contributes to the capacity development of active materials based on various oxidation states. Therefore, in order to use nickel in medium and large electric vehicles, the content of nickel should be increased as much as possible to produce high-energy cathode active materials (nickel (Ni)-rich NCM, Ni≥80%). However, as described above, as the content of nickel increases, the proportions of cobalt and manganese, which contribute to output and stability, decrease and thus the output or lifespan stability of the battery decreases.

Methods of surface-coating or doping the active material with various materials in order to compensate for the drawbacks have been proposed. Thereamong, interest in methods for forming carbon coatings is increasing.

When cathode active material particles are coated with carbon to form carbon coatings, the surface is first coated with an organic material (sucrose, glycol, or the like) and then subjected to post-thermal carbonization to obtain a highly conductive carbonized coating layer.

At the instant time, as the carbonization temperature increases, a carbonized coating layer containing highly crystalline carbon can be obtained and electrical conductivity can be improved. Therefore, the post-thermal carbonization is performed in an inert Ar atmosphere at a temperature of 400° C. or higher.

However, oxide-based active materials are vulnerable to heat treatment in a high-temperature inert Ar atmosphere, making high-temperature carbonization impossible. The process is disadvantageously very limitedly applicable to polyanion-based cathode materials (such as LiFePO₄) or highly stable oxides (such as Li₄Ti₅O₁₂ and NaCrO₂) with excellent crystallinity stability, and is inapplicable to Ni-rich materials with low stability.

As an alternative to the carbonization heat treatment of oxides, carbon sputtering may be used to form a carbon coating on the surface of the active material, but it is difficult to form a carbon coating with high crystallinity and high conductivity and it is also difficult to realize mass production due to limitations in carbon sputtering process equipment.

The information included in this Background of the present disclosure section is only for enhancement of understanding of the general background of the present disclosure and may not be taken as an acknowledgement or any form of suggestion that this information forms the related art already known to a person skilled in the art.

### BRIEF SUMMARY

Various aspects of the present disclosure are directed to providing a cathode active material that is imparted with improved electrical conductivity and reduced electrolyte side reactions and thus improved electrochemical performance through a coating layer with high crystallinity and high conductivity formed without separate heat treatment or solvent by physically displacing graphene separately prepared from a core on the surface of a core layer, and a method of preparing the same.

The objects to be solved by the present disclosure are not limited to those mentioned above and other objects not mentioned herein can be clearly understood by those skilled in the art from the following description.

In accordance with an aspect of the present invention, the above and other objects can be accomplished by the provision of a cathode active material for lithium secondary batteries including a core containing a material represented by the following Formula 1, and a coating layer formed on a surface of the core, wherein the coating layer contains graphene.

LiNi_{X}Co_{Y}Mn_{Z}M_{1-Y-Z}O₂ [Formula 1]
wherein M is Sc, Ti, V, Cr, Fe, Co, Ni, Cu, Zn, Y, Zr, Nb, Mo, Tc, Ru, Rh, Pd, Ag, Cd, Al, Ga, In, Sn, Bi or Mn, and
x, y, and z satisfy 0.3<x<1, 0<y<0.4, and 0<z<0.7, respectively.

In an exemplary embodiment of the present disclosure, the coating layer may be present in an amount of 0.5 to 2 wt %, based on a total of 100 wt % of the cathode active material.

In an exemplary embodiment of the present disclosure, the coating layer may have a thickness of 1 to 20 um.

In an exemplary embodiment of the present disclosure, the graphene may have a BET specific surface area of 100 to 750 m²/g.

In an exemplary embodiment of the present disclosure, the graphene may have an average particle diameter (D₅₀) of 1 to 5 nm.

In an exemplary embodiment of the present disclosure, the graphene may have a ratio of D/G of 0.5 to 1.2 when measured by Raman spectroscopy.

In an exemplary embodiment of the present disclosure, photoelectrons may be detected by graphene upon X-ray photoelectron spectroscopy (XPS).

In accordance with another aspect of the present invention, there is provided a method of preparing a cathode active material for lithium secondary batteries including preparing a core containing a material represented by the following Formula 1, preparing particulate graphene, and physically placing graphene on a surface of the core to form a coating layer containing graphene.

LiNi_{X}Co_{Y}Mn_{Z}M_{1-Y-Z}O₂ [Formula 1]
wherein M is Sc, Ti, V, Cr, Fe, Co, Ni, Cu, Zn, Y, Zr, Nb, Mo, Tc, Ru, Rh, Pd, Ag, Cd, Al, Ga, In, Sn, Bi or Mn, and
x, y, and z satisfy 0.3<x<1, 0<y<0.4, and 0<z<0.7, respectively.

In an exemplary embodiment of the present disclosure, in the formation of the coating layer, the coating layer may be present in an amount of 0.5 to 2 wt %, based on a total of 100 wt % of the cathode active material.

In an exemplary embodiment of the present disclosure, in the formation of the coating layer, the coating layer may be formed to a thickness of 1 to 20 μm.

In an exemplary embodiment of the present disclosure, in the formation of the coating layer, the graphene may have a BET specific surface area of 100 to 750 m²/g.

In an exemplary embodiment of the present disclosure, in the formation of the coating layer, the graphene has a ratio of D/G of 0.5 to 1.2, when measured by Raman spectroscopy.

In an exemplary embodiment of the present disclosure, in the formation of the coating layer, the graphene has an average particle diameter (D₅₀) of 1 to 5 nm.

In an exemplary embodiment of the present disclosure, in the formation of the coating layer, the coating layer may be physically formed on a surface of the core through dry milling using stirring after injecting core particles and graphene particles into a chamber.

In an exemplary embodiment of the present disclosure, the dry milling may be performed by stirring at 1,000 to 4,000 rpm.

In an exemplary embodiment of the present disclosure, the dry milling may be performed for 10 to 20 minutes.

In an exemplary embodiment of the present disclosure, the formation of the coating layer may be performed at room temperature.

In accordance with another aspect of the present invention, there is provided an electrode for a lithium secondary battery containing the cathode active material.

In accordance with another aspect of the present invention, there is provided a lithium secondary battery containing the cathode active material.

### BRIEF DESCRIPTION OF THE DRAWINGS

FIG. 1 is a schematic diagram illustrating a method of preparing a cathode active material for lithium secondary batteries of the present disclosure;

FIG. 2 is a schematic diagram illustrating a process of forming a coating layer by physically disposing graphene on a core surface of the cathode active material for lithium secondary batteries of the present disclosure;

FIG. 3 is a schematic diagram illustrating the cathode active material for lithium secondary batteries of the present disclosure;

FIG. 4 is an image showing the cathode active material for lithium secondary batteries of the present disclosure;

FIG. 5 is an image showing the surface of the cathode active material for lithium secondary batteries of the present disclosure;

FIG. 6 is a graph showing the result of X-ray photoelectron spectroscopy (XPS) of Example 1;

FIG. 7 is a graph showing the result of X-ray photoelectron spectroscopy (XPS) of Comparative Example 1;

FIG. 8 is a graph showing the results of Raman spectroscopy of Examples and Comparative Examples, and graphene and the resulting D/G ratio;

FIG. 9 is a graph showing electrical conductivity as a function of particle density of Examples and Comparative Examples;

FIG. 10 is a graph showing the charging capacity as a function of charging/discharging cycles of Examples and Comparative Examples;

FIG. 11 is a graph showing charging capacity as a function of rate in Examples and Comparative Examples;

FIG. 12 is a graph measuring charging capacity as a function of rate in Examples and Comparative Examples; and

FIG. 13 is a graph measuring the charging capacity as a function of charging/discharging cycles of Examples and Comparative Examples.

It may be understood that the appended drawings are not necessarily to scale, presenting a somewhat simplified representation of various features illustrative of the basic principles of the present disclosure. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments. On the contrary, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Reference will now be made in detail to the exemplary embodiments of the present invention, examples of which are illustrated in the accompanying drawings. However, the present invention is not limited to the embodiments and will be embodied in different forms. Those skilled in the art will appreciate that various modifications, additions and substitutions are possible, without departing from the scope and spirit of the present disclosure as included in the accompanying claims.

It will be understood that the terms may be used herein only to illustrate specific embodiments and should not be construed as limiting the scope of the present invention. Singular forms are intended to include plural forms as well, unless the context clearly indicates otherwise.

It will be further understood that the terms “comprises”, “has” and the like, when used in the present specification, specify the presence of stated features, numbers, steps, operations, elements, components or combinations thereof, but do not preclude the presence or addition of one or more other features, numbers, steps, operations, elements, components, or combinations thereof.

As used herein, the size of the pore refers to an average of diameters of pores present in the cathode active material. That is, the size may refer to an average diameter of pores.

As used herein, the average particle diameter (D50) may be defined as a particle size corresponding to 50% of the cumulative volume in a particle size distribution curve. The average particle diameter (D50) may be measured using, for example, a laser diffraction method. The laser diffraction method is generally capable of measuring particle diameters ranging from submicron to several millimeters and obtaining results with high reproducibility and high resolution.

In an exemplary embodiment of the present disclosure, the specific surface area of the silicon-based composite may be measured by the Brunauer-Emmett-Teller (BET) method. For example, the specific surface area may be measured using the BET 6-point method by nitrogen gas adsorption and desorption using a porosimetry analyzer (Bell Japan Inc, Belsorp-Ilmini). In addition to the devices, devices used in the art may be appropriately employed.

X-ray photoelectron spectroscopy (XPS) is a test method to measure the components and bonding characteristics of the surface of a sample by applying X-rays to the sample and thereby to detect the kinetic energy and intensity of photoelectrons emitted by the photoelectric effect. For example, the measurement may be performed using an XPS meter (Thermo Fisher Scientific Inc, Nexsa G2 surface analysis system). In addition to the devices, devices used in the art may be appropriately employed.

Raman spectroscopy is based on the Raman effect. When a laser is irradiated to a specific molecule, energy corresponding to the difference in the energy level of the electrons of the molecule is absorbed. Through this phenomenon, the surface state of the molecule can be determined and the degree of fracture of the sample can be measured based thereon. Specifically, the degree of fracture of the sample may be measured using a Raman spectrometer (ReactRaman 802L, METTLER TOLEDO. Inc).

The present invention aims at providing a cathode active material that is imparted with improved electrical conductivity and reduced electrolyte side reactions and thus improved electrochemical performance through a coating layer with high crystallinity and high conductivity formed without separate heat treatment or solvent by physically displacing graphene prepared separately from a core on the surface of the core layer, and a method of preparing the same.

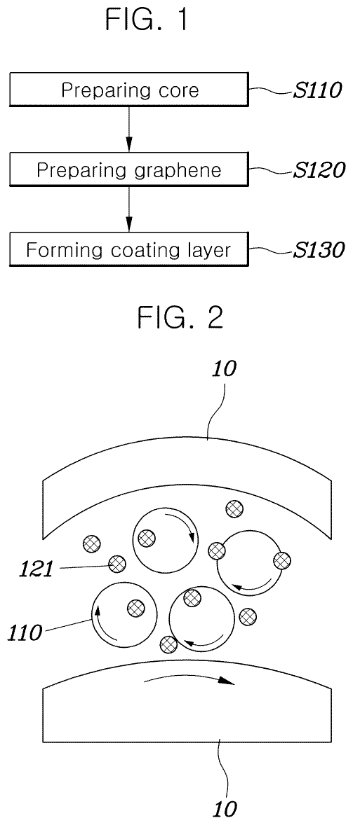

FIG. 1 is a flowchart illustrating a method of manufacturing a cathode active material for a lithium secondary battery of the present invention, and FIG. 2 is a schematic diagram illustrating a process of forming a coating layer by physically disposing graphene on a core surface of the cathode active material for lithium secondary batteries of the present invention. With reference to this, the method of preparing the cathode active material for lithium secondary batteries of the present invention will be described.

The method of preparing the cathode active material for a lithium secondary battery of the present invention may include preparing a core (S110).

At the instant time, the core 110 may include a material represented by Formula 1:

LiNi_{X}Co_{Y}Mn_{Z}M_{1-Y-Z}O₂ [Formula 1]
wherein M is Sc, Ti, V, Cr, Fe, Co, Ni, Cu, Zn, Y, Zr, Nb, Mo, Tc, Ru, Rh, Pd, Ag, Cd, Al, Ga, In, Sn, Bi or Mn, and x, y, and z satisfy 0.3<x<1, 0<y<0.4, and 0<z<0.7, respectively.

Particulate graphene may be prepared separately from the core (S120).

The graphene particles 121 used in the process may have a BET specific surface area of 100 to 750 m²/g. As can be seen from the following examples, the cathode active material for a lithium secondary battery that satisfies the range defined above may exhibit excellent performance.

The average particle diameter (D₅₀) of the graphene particles 121 may be 1 to 5 nm. This may be because it is difficult to control the process when the average particle diameter (D₅₀) is below the range, and because the coating layer cannot be effectively formed when the average particle diameter (D₅₀) is above the range.

The graphene particles 121 may have a D/G ratio of 0.7 to 1.2 when measured by Raman spectroscopy. As can be seen from examples to be described later, the cathode active material for a lithium secondary battery that satisfies the above range may exhibit excellent performance.

Then, the graphene particles 121 may be physically disposed on the surface of the core 110 to form a coating layer 120 containing graphene (S130).

At the instant time, the coating layer 120 may be formed so that the graphene particles 121 are disposed on the surface of the core 110.

The thickness of the coating layer 120 may be adjusted to 1 to 20 μm. This is because it is difficult to effectively increase the battery conductivity of the cathode active material when the thickness of the coating layer is excessively small, and because the ionic conductivity of the cathode active material may be lowered and metal ions including lithium ions may be exposed to the outside during charging and discharging when the thickness of the coating layer is excessively great.

The content of the coating layer 120 may be 0.5 to 2 wt % based on a total of 100 wt % of the cathode active material. This is because the cathode active material for a lithium secondary battery that satisfies the range exhibits excellent performance, as can be seen from the examples described later.

At the instant time, the core 110 and the graphene particles 121 are added together, followed by physical stirring. The resulting graphene particles 121 are disposed on the surface of the core 110, forming a coating layer 120 containing graphene on the surface of the core.

As shown in FIG. 2, the core 110 and the graphene particles 121 are added and then the graphene particles 121 are physically disposed on the surface of the core 110 by dry milling based on stirring, to form a coating layer 120 containing graphene particles 121 on the surface of the core 110.

The dry milling may be performed by stirring at 1,000 to 4,000 RPM for 10 to 20 minutes.

In addition, this process may be performed at room temperature without separate heat treatment.

In a process of forming the coating layer by placing graphene on the surface of the core through milling, graphene may be pulverized.

In general, in order to form a carbon coating on cathode active material particles, the surface thereof is coated with an organic material (sucrose, glycol, or the like) and is then subjected to post-thermal carbonization to obtain a highly conductive carbonized coating layer. For this reason, methods of coating the surface of active material particles with carbon require an aqueous solution process and high temperature treatment in an inert gas environment.

However, nickel (Ni)-rich NCM (in particular, LiNi_{0.8}Co_{0.1}Mn_{0.1}O₂(NCM811) at a Ni:Co:Mn molar ratio of 8:1:1) may be inapplicable to carbon coating because, in an aqueous medium, impurities such as lithium synthesis residues present on the surface react with the solvent and thus cause electrochemically inactive substances to be left on the surface, or exchange between hydrogen ions and lithium ions.

Moreover, not only graphene but also metal oxides are reduced under high temperature treatment conditions. Heat treatment at a relatively low temperature in order to avoid this may cause an additional problem in which the sp2 structure of graphene cannot be sufficiently obtained.

Therefore, a method of effectively forming a carbon coating on metal oxide with low stability (particularly, thermal stability) and high sensitivity to moisture, such as nickel-rich NCM, is required.

In order to solve this problem, the method of preparing a cathode active material for a lithium secondary battery of the present invention adopts physically placing separately prepared graphene on the surface of the core to form a coating layer.

As shown in FIG. 2, graphene 121 prepared separately from the core 110 is introduced into the chamber 10 and then the coating layer 120 may be formed on the surface of the core 110 through dry milling based on stirring.

Since a carbon coating layer is formed by placing graphene that has been separately prepared and already carbonized on the surface of the core 110, separate heat treatment for carbonization, such as exposure to a high-temperature inert Ar environment, may not be required for the cathode active material.

In addition, since the coating layer 120 containing graphene is formed by dry milling, a separate solvent may not be needed.

Therefore, a highly conductive and highly crystalline carbon coating layer can be effectively formed on a core containing metal oxide that has low stability (particularly thermal stability) and high sensitivity to moisture, such as nickel-rich NCM.

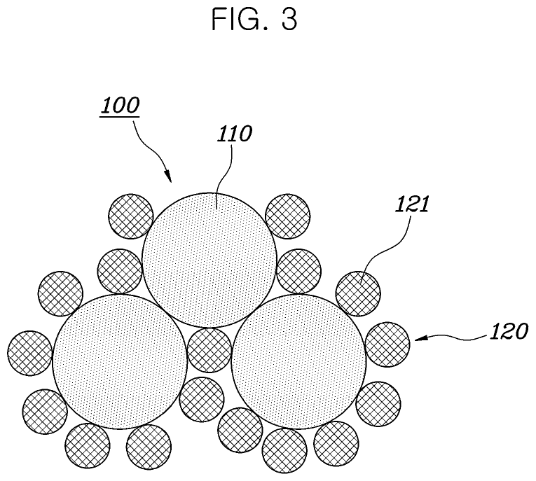

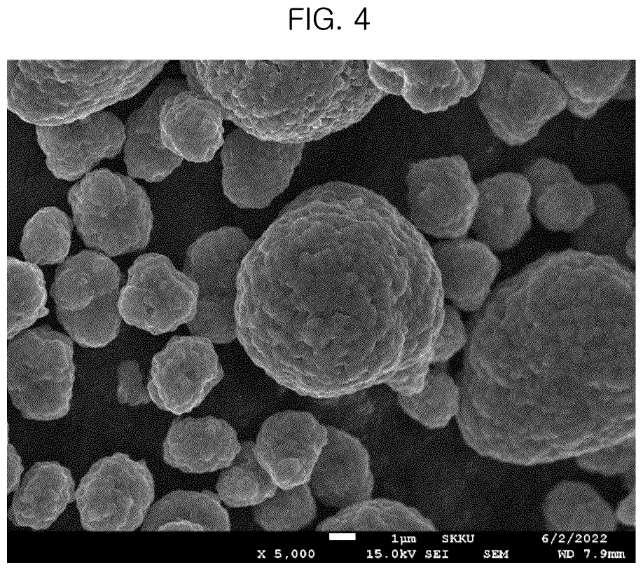

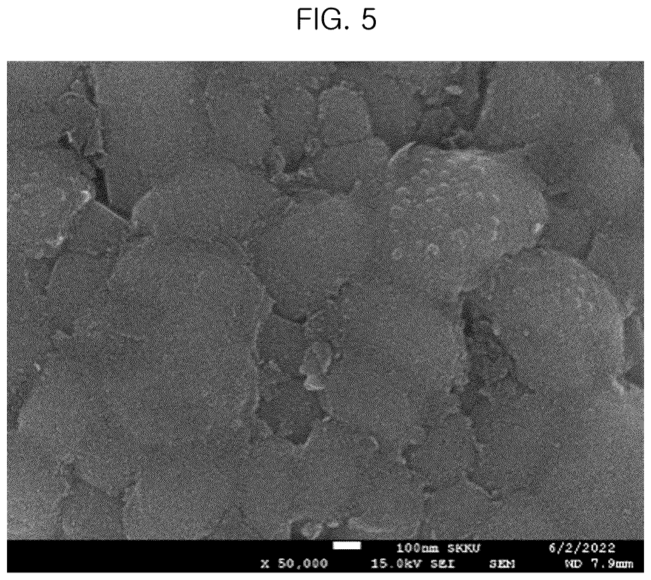

FIG. 3 is a schematic diagram illustrating the cathode active material for lithium secondary batteries of the present invention, FIG. 4 is an image showing the cathode active material for lithium secondary batteries of the present invention, and FIG. 5 is an image showing the surface of the cathode active material for lithium secondary batteries of the present invention. With reference to these drawings, the cathode active material for lithium secondary batteries of the present invention will be described.

The cathode active material 100 for a lithium secondary battery of the present invention includes a core 110 containing lithium and a coating layer 120 formed on the surface of the core, wherein the coating layer contains graphene particles 121.

For example, the cathode active material includes the core 110 containing a material represented by Formula 1 and a coating layer 120 containing graphene, wherein the coating layer may be formed by coating the surface of the core with graphene particles 121 prepared separately from the core.

LiNi_{X}Co_{Y}Mn_{Z}M_{1-Y-Z}O₂ [Formula 1]
wherein M is Sc, Ti, V, Cr, Fe, Co, Ni, Cu, Zn, Y, Zr, Nb, Mo, Tc, Ru, Rh, Pd, Ag, Cd, Al, Ga, In, Sn, Bi or Mn, and x, y, and z satisfy 0.3<x<1, 0<y<0.4, and 0<z<0.7, respectively.

In addition, the coating layer 120 may contain graphene particles 121 and be formed on the surface of the core 110. At the instant time, the coating layer 120 may be formed on the surface of the core 110 as shown in FIG. 4 and FIG. 5.

The thickness of the coating layer 120 may be 1 to 20 μm.

The content of the coating layer 120 may be 0.5 to 2 wt %, based on a total of 100 wt % of the cathode active material.

The graphene particles 121 contained in the coating layer may have a BET specific surface area of 100 to 750 m²/g.

The average particle diameter (D₅₀) of the graphene particles 121 may be 1 to 5 nm.

The graphene particles 121 may have a D/G ratio of 0.7 to 1.2 when measured by Raman spectroscopy.

On the other hand, during X-ray photoelectron spectroscopy (XPS), first photoelectrons having an energy of 286.3 to 286.7 eV due to C—O bond, second photoelectrons having an energy of 288.8 to 289.3 eV due to O—C—O bond, and third photoelectrons having an energy of 289.56 to 292.26 eV due to π-π* bonding can be observed from the cathode active material for lithium secondary batteries of the present invention, which may result from graphene disposed in the coating layer on the core surface.

The electrode for a lithium secondary battery of the present invention or the lithium secondary battery may contain the cathode active material for a lithium secondary battery of the present invention.

### <Anode>

The anode active material may also be formed using a material that may deintercalate lithium ions or cause a conversion reaction.

The anode active material may be mixed with a conductive material and a binder to obtain an anode material.

The anode material may be applied onto a cathode current collector to form an anode. The cathode current collector may be a conductor. The applying the anode material onto the cathode current collector may be performed by preparing a paste using pressure-molding or an organic solvent, applying the paste to the current collector, and pressing to fix the paste thereto.

### <Electrolyte>

The electrolyte may contain lithium. In addition, an electrolyte containing fluorine may be used. In addition, the electrolyte may be dissolved in an organic solvent and used as a non-aqueous electrolyte solution. Alternatively, a solid electrolyte may be used as well. In addition, the solid electrolyte may act as a separator, which will be described later. In the instant case, a separator may not be required.

### <Separator>

A separator may be interposed between the anode and the cathode. This separator may be a material in a form of a porous film, non-woven fabric, or woven fabric. The thickness of the separator is preferably as thin as possible as long as mechanical strength is maintained in that the volumetric energy density of the battery increases and internal resistance decreases.

### <Method of Producing Alkaline Metal Secondary Battery>

A cathode, a separator, and an anode are stacked in this order to form an electrode group, the electrode group is accommodated in a battery can (after being rolled, if necessary), and impregned with a non-aqueous electrolyte to manufacture a secondary battery. Alternatively, a cathode, a solid electrolyte, and an anode are stacked in this order to form an electrode group, the electrode group is accommodated in a battery can (after being rolled, if necessary), and impregnated with a non-aqueous electrolyte to manufacture a secondary battery.

Hereinafter, exemplary examples (experimental examples) are provided for better understanding of the present invention. However, the following experimental examples are provided only for better understanding of the present invention and should be not construed as limiting the scope of the present invention.

### Examples and Comparative Examples

### Example 1

LiNi_{0.89}Co_{0.04}Mn_{0.07}O₂ particles and graphene particles having a BET specific surface area of 500 m²/g were injected into a milling machine and coating was performed at 3,000 rpm for 10 minutes. At the instant time, the content of graphene particles is 0.5 wt % based on a total of 100 wt % of the cathode active material.

The milling machine used herein has no blades and uses a method of rotating the cylindrical rotating center at high speed.

The prepared graphene-active material, the conductive material and the binder was dissolved at a ratio of 99.2:0:0.8 in NMP as a solvent to prepare a slurry.

An aluminum substrate was coated with the slurry, dried, rolled, and dried in a vacuum oven to produce an R2032-type coin cell.

### Example 2

A coin cell was produced in the same manner as Example 1, except that graphene having a specific surface area of 300 m²/g was used.

### Example 3

A coin cell was produced in the same manner as Example 1, except that graphene having a specific surface area of 750 m²/g was used.

### Example 4

A coin cell was produced in the same manner as Example 1, except that graphene was used in an amount of 0.3 wt %.

### Example 5

A coin cell was produced in the same manner as Example 1, except that graphene was used in an amount of 1 wt %.

### Example 6

A coin cell was produced in the same manner as Example 1, except that graphene was used in an amount of 2 wt %.

### Comparative Example 1

A coin cell was produced in the same manner as Example 1, except that no graphene was added.

### Comparative Example 2

A coin cell was produced in the same manner as Example 1, except that graphene was simply mixed in the same amount as in Example 1 without coating.

### Comparative Example 3

A coin cell was produced in the same manner as Example 1, except that CNT was used in an amount of 1 wt %, instead of graphene.

### Comparative Example 4

A coin cell was produced in the same manner as Example 1, except that Super-P was used instead of graphene.

### Experiment Example

### Results of X-Ray Photoelectron Spectroscopy (XPS)

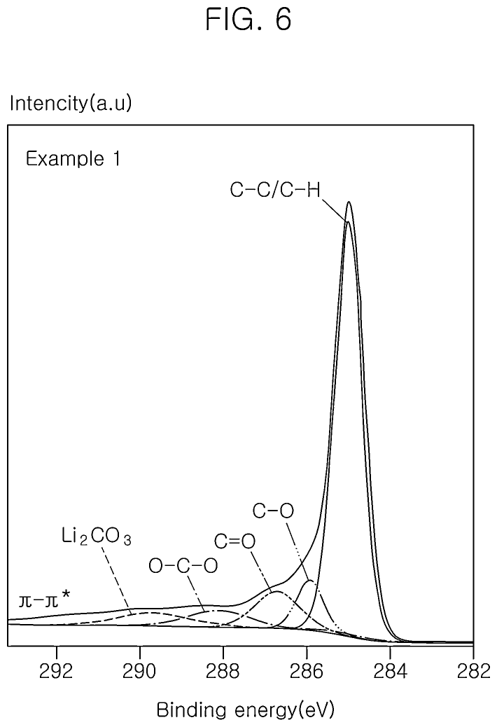

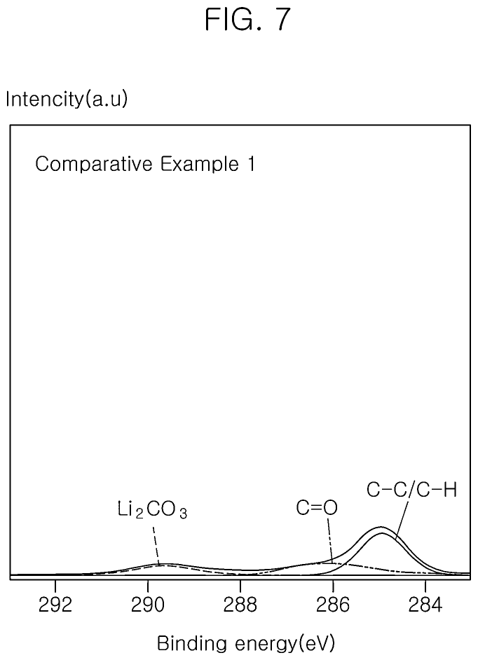

FIG. 6 and FIG. 7 are graphs showing the results of X-ray photoelectron spectroscopy (XPS) of Example 1 and Comparative Example 1, and Table 1 shows the results of X-ray photoelectron spectroscopy (XPS) of Example 1 and Comparative Example 1.

TABLE 1

| | C (%) | Li (%) | Ni (%) | Co (%) | Mn (%) | O (%) |
|---|---|---|---|---|---|---|
| Comparative | 10.77 | 16.11 | 6.99 | 0.35 | 1.60 | 64.18 |
| Example 1 | | | | | | |
| Example 1 | 59.63 | 5.83 | 2.97 | 0.41 | 0.74 | 30.42 |

Table 1 shows the content (%) of each element present on the surface of the cathode active material as a result of XPS.

As can be seen from FIG. 6 and FIG. 7 and Table 1, in Example 1, a first peak was observed due to a photoelectron having the corresponding energy at 286.3 to 286.7 eV based on the C—O bond, a second peak was observed due to a photoelectron having the corresponding energy at 288.8 to 289.3 eV based on the O—C—O bond, and a third peak was observed due to a photoelectron having the corresponding energy at 289.56 to 292.26 eV due to the π-π* bond, whereas in Comparative Example 1, the corresponding peaks were not observed. In addition, it can be seen that more C (carbon) is present on the surface of Example 1 than on the surface of Comparative Example 1.

This shows that, in Example 1, graphene is present on the surface of the core and that the graphene is physically disposed on the surface of the core so that a coating layer containing carbon is effectively formed. This also shows that, in Comparative Example 1 in which graphene was not added, a coating layer containing graphene, that is, carbon, is not formed.

### Results of Raman Spectroscopy

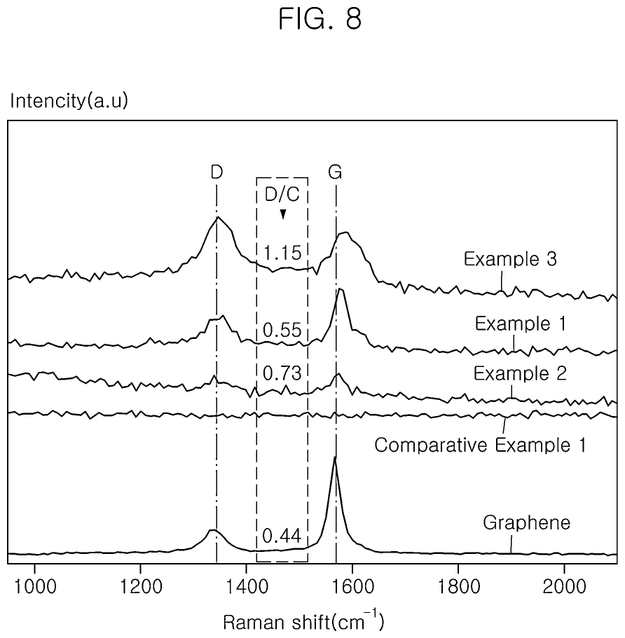

FIG. 8 is a graph showing the results of Raman spectroscopy of Examples and Comparative examples and the resulting D/G ratios, and Table 2 is a graph showing the D/G ratios of Examples, Comparative Examples, and graphene.

TABLE 2

| | Comparative | | Example | Example | Example |
|---|---|---|---|---|---|
| | Example 1 | Graphene | 1 | 2 | 3 |
| D/G | — | 0.44 | 0.55 | 0.73 | 1.15 |

The result of Raman spectroscopy showed that, as the D/G ratio increases, the degree of particle pulverization increases. In addition, graphene has a specific surface area of 500 m²/g and the ratio of D/G of the graphene was measured using Raman spectroscopy without any additional treatment.

As can be seen from FIG. 8 and Table 2, in Comparative Example 1 in which graphene was not added, the core was large compared to the graphene particles and was not sufficiently pulverized, so a significant D/G ratio was not measured.

In addition, it can be seen that Examples 1 to 3 in which coating is performed by milling have a high D/G ratio, compared to graphene with a specific surface area of 500 m²/g.

This shows that the graphene is pulverized while the coating layer is formed by placing graphene on the core surface through milling. This shows that a coating layer is effectively formed from the micronized graphene on the surface of the core.

### Comparison of Electrical Conductivity

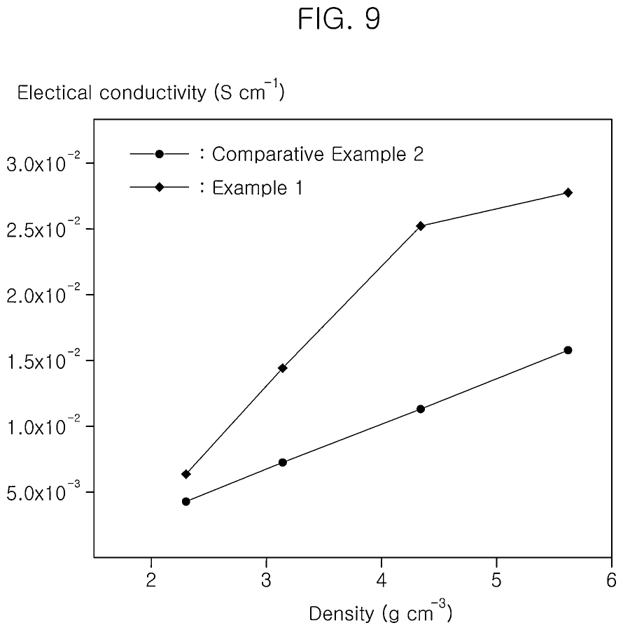

FIG. 9 is a graph showing electrical conductivity as a function of particle density of Examples and Comparative Examples.

As can be seen from FIG. 9, Example 1, in which a coating layer containing graphene is formed, has higher electrical conductivity at all particle densities than Comparative Example 1 in which graphene was not added.

This shows that the coating layer containing graphene of the present invention is effective in improving the electrical conductivity of the cathode active material.

### Comparison of Capacity Vs Charging Rate (Graphene Content)

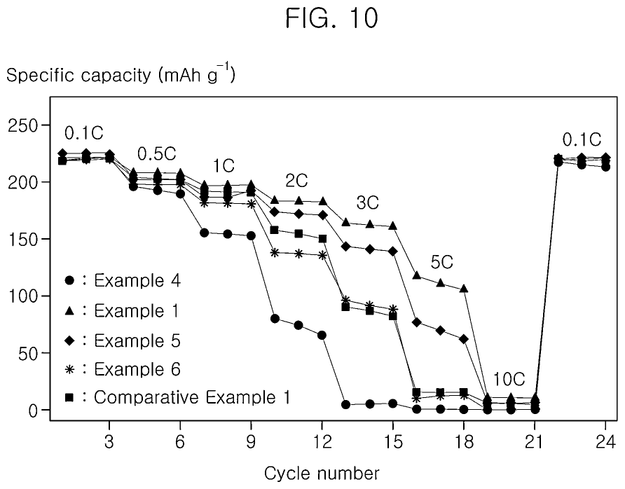

FIG. 10 is a graph showing the charging capacity as a function of charging/discharging cycles of Examples and Comparative Examples and Table 3 shows the charging capacity as a function of charging/discharging cycles of Examples and Comparative Examples.

TABLE 3

| | 0.1 C | 0.5 C | 1 C | 2 C | 3 C | 5 C | 10 C |
|---|---|---|---|---|---|---|---|
| Comparative | 219.9 | 203.6 | 192.3 | 157.4 | 90.0 | 14.6 | 4.8 |
| Example 1 | | | | | | | |
| (0 wt %) | | | | | | | |
| Example 4 | 223.2 | 196.3 | 156.0 | 80.1 | 4.4 | 0.0 | 0.0 |
| (0.3 wt %) | | | | | | | |
| Example 1 | 219.1 | 206.7 | 196.4 | 182.8 | 163.9 | 117.6 | 9.2 |
| (0.5 wt %) | | | | | | | |
| Example 5 | 223.1 | 202.7 | 156.2 | 173.6 | 143.3 | 76.1 | 5.5 |
| (1 wt %) | | | | | | | |
| Example 6 | 218.5 | 198.8 | 181.9 | 138.0 | 96.3 | 10.0 | 0.1 |
| (2 wt %) | | | | | | | |

Examples and Comparative Examples showed the content of graphene based on 100 wt % of the cathode active material, and the charging capacity as a function of rate (C) of Experimental Examples and Comparative Examples was measured.

In addition, the experiment was conducted at 2.75 to 4.3V and at room temperature of 25° C. and the unit of charge capacity is mAh/g.

As can be seen from FIG. 10 and Table 3, Example 1 with a graphene content of 0.5 wt % and Example 6 with a graphene content of 1 wt % have a higher yield than Comparative Example 1 in which no graphene was added (0 wt %). It can be seen that Example 5, in which the content of graphene is 0.5 wt %, have the highest charging capacity as a function of rate.

It can be seen that Example 4, in which the content of graphene was 0.3 wt %, has a low charging capacity as a function of rate, compared to Comparative Example 2 in which no graphene was added (0 wt %).

In addition, it can be seen that Example 6 in which the content of graphene was 2.0 wt % has a substantially similar charging capacity as a function of rate compared to Comparative Example 2 in which no graphene was added (0 wt %).

This shows that high charging capacity was achieved when the content of graphene was 0.5 to 2.0 wt % based on a total of 100 wt % of the cathode active material.

### Comparison of Capacity Vs Charging Rate (Graphene and CNT)

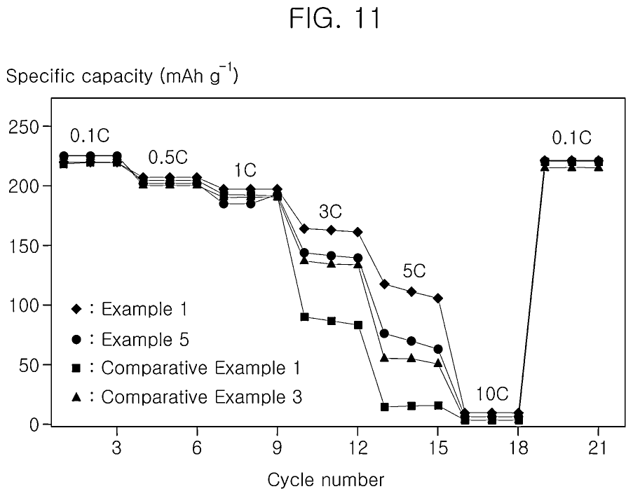

FIG. 11 is a graph showing charging capacity as a function of rate in Examples and Comparative Examples. The charging capacity depending on graphene content and rate (C) was measured and the experiment was conducted at 2.75 to 4.3V and at room temperature of 25° C.

As can be seen from FIG. 11, Examples and Comparative Examples had almost the same charging capacity at a rate of 0.1 C to 1 C, which is a low-rate charging and discharging condition.

However, at rates of 3 C and 5 C, which are high-rate charging and discharging conditions, Example 1 with a graphene content of 0.5 wt % had the highest charging capacity as a function of rate, whereas Example 5 with a graphene content of 1 wt % had the second highest charging capacity, and Comparative Example 3 in which the content of carbon nanotube (CNT) is 1 wt % had the third highest charging capacity as a function of rate. Comparative Example 1 in which no graphene was added (0 wt %) had the lowest charging capacity as a function of rate.

This shows that coating the surface of the cathode active material for lithium secondary batteries of the present invention with graphene effectively maintained the charging capacity at a high rate compared to not-coating the surface and coating the surface with carbon nanotubes (CNT).

### Comparison of Charging Capacity as Function of Rate (Graphene and Super-P)

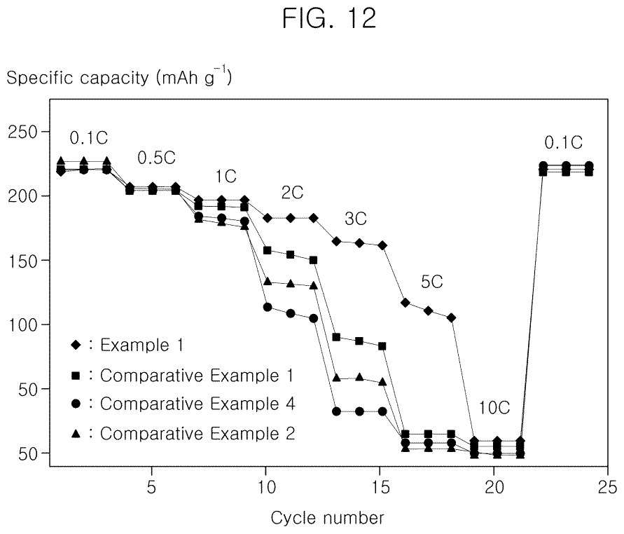

FIG. 12 is a graph showing the charging capacity as a function of charging rate of Examples and Comparative Examples. In Examples and Comparative Examples, the charging capacity depending on the content of graphene and rate (C) was measured, and the experiment was conducted at 2.75 to 4.3 V and at room temperature of 25° C.

As can be seen from FIG. 12, Examples and Comparative Examples had almost the same charging capacity as function of rate at a rate of 0.1 C to 1 C, which is a low-rate charging and discharging condition.

As can be seen from FIG. 12, Examples and Comparative Examples had almost the same charging capacity as function of rate at a rate of 0.1 C to 1 C, which is a low-rate charging and discharging condition.

However, at rates of 3 C and 5 C, which are high-rate charging and discharging conditions, Example 1 with a graphene content of 0.5 wt % had the highest charging capacity as a function of rate, Comparative Example 1 in which no graphene was added (0 wt %) had the second highest charging capacity as a function of rate, and Comparative Example 2 in which graphene was simply mixed had the third highest charging capacity as a function of rate. Comparative Example 4 in which Super-P is used instead of graphene had the lowest charging capacity as a function of rate.

This shows that coating the surface of the cathode active material for lithium secondary batteries of the present invention with graphene effectively maintained the charging capacity at a high rate compared to not-coating the surface and coating the surface thereof with Super-P.

### Comparison of Capacity as Function of Charging/Discharging Cycle (Graphene Specific Surface Area)

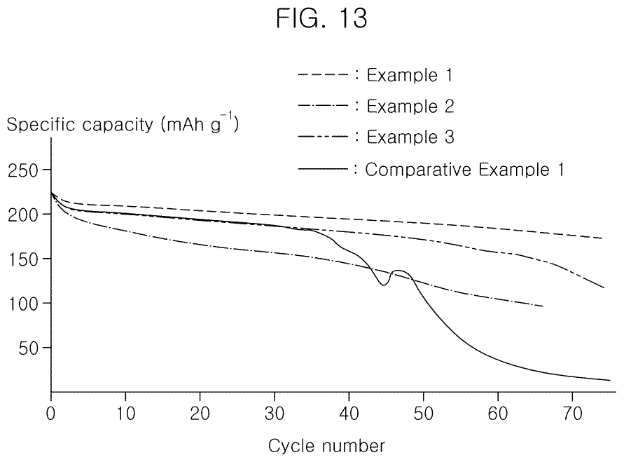

FIG. 13 is a graph showing the charging capacity as a function of charging/discharging cycle of Examples and Comparative Examples. In Examples and Comparative Examples, the charging capacity depending on the content of graphene and rate (C) was measured and the experiment was conducted at 2.75 to 4.3 V and at room temperature of 25° C.

As can be seen from FIG. 13, Example 1 with a graphene specific surface area of 500 m²/g had the best charging capacity as a function of charging/discharging cycle, Example 3 with a graphene specific surface area of 750 m²/g had the second-best charging capacity as a function of charging/discharging cycle, and Example 5 with a graphene specific surface area of 300 m²/g had the third-best charging capacity as a function of charging/discharging cycle. Comparative Example 1 in which no graphene was added (0 wt %) had the poorest charging capacity as a function of charging/discharging cycle.

This shows that coating the surface of the cathode active material for lithium secondary batteries of the present invention with graphene effectively maintains charging capacity as a function of charging/discharging cycle.

This indicates that coating the surface of the cathode active material for lithium secondary batteries of the present invention with graphene effectively maintains charging capacity as a function of charging/discharging cycle, compared to non-coating.

As apparent from the foregoing, various aspects of the present disclosure are directed to providing a cathode active material that is imparted with improved electrical conductivity and reduced electrolyte side reactions and thus improved electrochemical performance through a coating layer with high crystallinity and high conductivity formed without separate heat treatment or solvent by physically displacing graphene prepared separately from a core on the surface of a core layer, and a method of preparing the same.

The effects that can be obtained from the present invention are not limited to those mentioned above and other effects not mentioned can be clearly understood by those skilled in the art from the description above.

The foregoing descriptions of specific exemplary embodiments of the present invention have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the present disclosure and their practical application, to enable others skilled in the art to make and utilize various exemplary embodiments of the present invention, as well as various alternatives and modifications thereof. It is intended that the scope of the present disclosure be defined by the Claims appended hereto and their equivalents.

What is claimed is:

1. A cathode active material for lithium secondary batteries, the cathode active material comprising:
a core containing a material represented by a following Formula 1; and
a coating layer formed on a surface of the core, wherein the coating layer comprises graphene,
LiNi_{X}Co_{Y}Mn_{Z}M_{1-Y-Z}O₂ [Formula 1]
wherein M is Sc, Ti, V, Cr, Fe, Co, Ni, Cu, Zn, Y, Zr, Nb, Mo, Tc, Ru, Rh, Pd, Ag, Cd, Al, Ga, In, Sn, Bi or Mn, and
x, y, and z satisfy 0.3<x<1, 0<y<0.4, and 0<z<0.7, respectively.

2. The cathode active material of claim 1, wherein the coating layer has a thickness of 1 to 20 um.

3. The cathode active material of claim 1, wherein the coating layer is present in an amount of 0.5 to 2 wt %, based on a total of 100 wt % of the cathode active material.

4. The cathode active material of claim 1, wherein the graphene has a BET specific surface area of 100 to 750 m²/g.

5. The cathode active material of claim 1, wherein the graphene has an average particle diameter (D₅₀) of 1 to 5 nm.

6. The cathode active material of claim 1, wherein the graphene has a ratio of D/G of 0.5 to 1.2 when measured by Raman spectroscopy.

7. The cathode active material of claim 1, wherein a first peak is detected at 286.3 to 286.7 eV, a second peak is detected at 288.8 to 289.3 eV, and a third peak is detected at 289.56 to 292.26 eV, upon X-ray photoelectron spectroscopy (XPS).

8. A method of preparing a cathode active material for lithium secondary batteries, the method comprising:
preparing a core containing a material represented by a following Formula 1;
preparing particulate graphene separately from the core; and
physically placing graphene on a surface of the core to form a coating layer containing graphene,
LiNi_{X}Co_{Y}Mn_{Z}M_{1-Y-Z}O₂ [Formula 1]
wherein M is Sc, Ti, V, Cr, Fe, Co, Ni, Cu, Zn, Y, Zr, Nb, Mo, Tc, Ru, Rh, Pd, Ag, Cd, Al, Ga, In, Sn, Bi or Mn, and
x, y, and z satisfy 0.3<x<1, 0<y<0.4, and 0<z<0.7, respectively.

9. The method of claim 8, wherein, in the formation of the coating layer, the coating layer is present in an amount of 0.5 to 2 wt %, based on a total of 100 wt % of the cathode active material.

10. The method of claim 8, wherein, in the formation of the coating layer, the coating layer is formed to a thickness of 1 to 20 μm.

11. The method of claim 8, wherein, in the formation of the coating layer, the graphene has a BET specific surface area of 100 to 750 m²/g.

12. The method of claim 8, wherein, in the formation of the coating layer, the graphene has an average particle diameter (D₅₀) of 1 to 5 nm.

13. The method of claim 8, wherein, in the formation of the coating layer, the graphene has a ratio of D/G of 0.5 to 1.2, when measured by Raman spectroscopy.

14. The method of claim 8, wherein, in the formation of the coating layer, the coating layer is physically formed on a surface of the core through dry milling using stirring after injecting core particles and graphene particles into a chamber.

15. The method of claim 14, wherein the dry milling is performed by stirring at 1,000 to 4,000 rpm.

16. The method of claim 14, wherein the dry milling is performed for 10 to 20 minutes.

17. The method of claim 8, wherein the formation of the coating layer is performed at room temperature.

18. An electrode for a lithium secondary battery comprising the cathode active material of claim 1.

19. A lithium secondary battery comprising the cathode active material of claim 1.
